(19) United States
(12) Patent Application Publication
(10) Pub. No.: US 2006/0099883 A1
(43) Pub. Date: May 11, 2006

(54) Battery powered toy horseshoe electromagnet

(76) Inventor: Kwan S. Cheung, So. San Francisco, CA (US)

Correspondence Address: KEITH KLINE;THE KLINE LAW FIRM, 161 LITTLE POND LANE, PALMYRA, VA, 22963, US

(21) Appl. No.: 10/985,569

(22) Filed: Nov. 9, 2004

(51) Int. Cl. A63H 29/22; H01F 7/20

(52) U.S. Cl. 446/484; 335/293; 335/294

(57) ABSTRACT

A toy magnet is shaped to generally resemble a horseshoe magnet. The legs of the toy are in a U shape, with an enclosed handle area attached to a top end of the magnet section. A central section of the toy contains the power source, a battery pack. The handle area includes an activation switch and an LED display to indicate when the toy is energized so as to be in magnetic mode. Each leg of the toy contains an electromagnetic module. The electromagnetic module comprises a U-shaped iron core, with each leg of the iron core wrapped with a conductive wire winding. The conformation of the electromagnetic modules provides a large amount of windings in a small overall area, so that the magnetic field created is a strong and effective one.

### BACKGROUND OF THE INVENTION

1. Field of the Invention

The present invention relates generally to toys, and more particularly is a battery powered toy horseshoe electromagnet.

2. Description of the Prior Art

A common children's toy is a magnet. Children occupy themselves by picking up various objects, and discovering which materials are and are not attracted by the magnetic field. The horseshoe magnet, a generally flat magnet with a U shape, is a typical embodiment for a children's magnet.

Once children discover magnetism found in permanent magnets, they very often go on to explore the phenomenon of electromagnetism. The standard experiment is to attach a wire to a power source, generally a battery, and wrap the wire several times around a metallic element, usually a nail. When the circuit through the battery is closed, an electromagnetic field is generated around the nail so that the child is able to pick up objects subject to magnetic attraction with the nail.

The developer of the present invention felt it would be of interest to children to create an electromagnet that could be used again and again, without requiring assembly of several elements each time it is to be used. Accordingly, it is an object of the present invention to provide a battery powered electromagnet.

It is another object of the present invention to provide an electromagnet in the general shape of a horseshoe magnet.

It is still another object of the present invention to provide multiple coils associated with the electromagnet to create a relatively strong magnetic field.

### SUMMARY OF THE INVENTION

The present invention is a toy magnet shaped to generally resemble a horseshoe magnet. The legs of the toy are in a U shape, with an enclosed handle area attached to a top end of the magnet section. A central section of the toy contains the power source, a battery pack. The handle area includes an activation switch and an LED display to indicate when the toy is energized so as to be in magnetic mode.

Each magnetic leg of the toy contains an electromagnetic module. The electromagnetic module comprises a U-shaped iron core, with each leg of the iron core wrapped with a conductive wire winding. The conformation of the electromagnetic modules provides a large amount of windings in a small overall area, so that the magnetic field created is a strong and effective one.

An advantage of the present invention is that it provides a completely portable toy electromagnet.

Another advantage of the present invention is that its compact design provides a large amount of windings in a small overall volume, thereby creating a strong magnetic force with minimal space required.

These and other objects and advantages of the present invention will become apparent to those skilled in the art in view of the description of the best presently known mode of carrying out the invention as described herein and as illustrated in the drawings.

### BRIEF DESCRIPTION OF THE DRAWINGS

FIG. 1 is a perspective view of the toy electromagnet of the present invention.

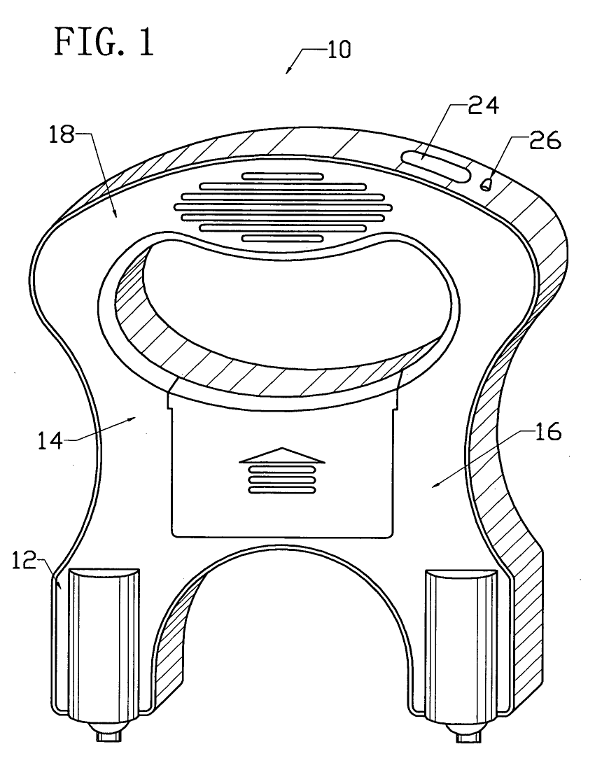

FIG. 2 is a perspective view of the toy electromagnet with the top cover removed.

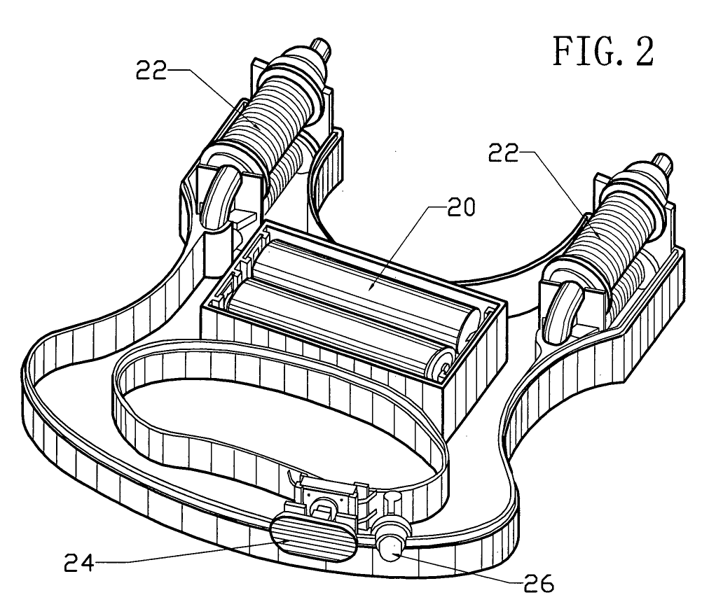

FIG. 3 is an exploded view of the toy electromagnet.

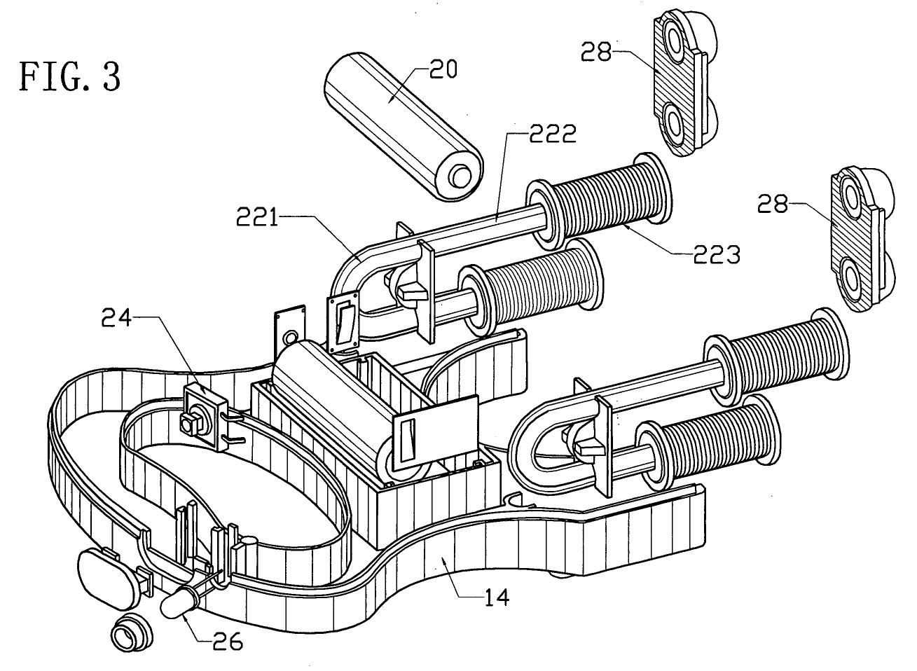

FIG. 4 is a perspective view of the electromagnetic module.

FIG. 5 is an exploded view of the electromagnetic module.

FIG. 6 is a wiring diagram of the toy electromagnet.

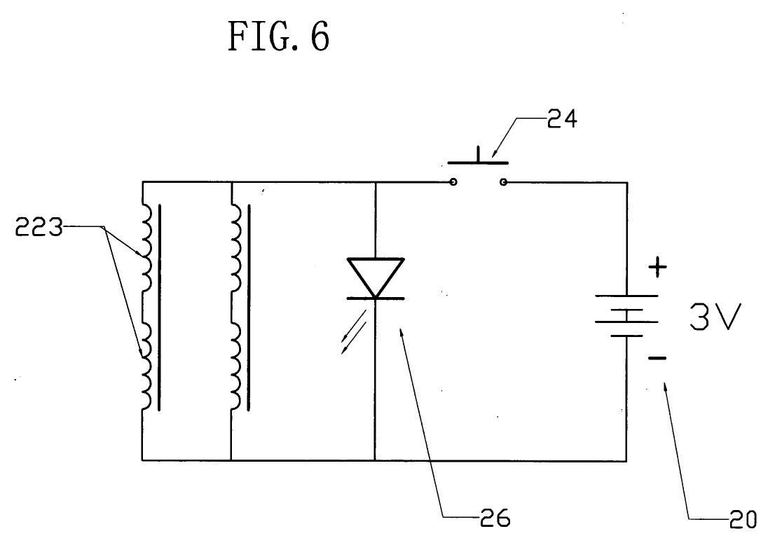

### DETAILED DESCRIPTION OF THE INVENTION

The present invention is a toy magnet 10 shaped to generally resemble a horseshoe magnet. The housing 12 of the toy 10 comprises a pair of legs 14 in a generally U shape to create the horseshoe image. The housing 12 further comprises a central section 16, and a handle area 18.

The central section 16 of the toy contains the power source 20, a battery pack. The battery pack 20 is in electrical communication with a pair of electromagnetic modules 22, and with a switch 24 and an LED 26 mounted in the handle area 18. The LED 26 lights when the switch 24 is closed so that the electromagnetic mode of the toy 10 is activated.

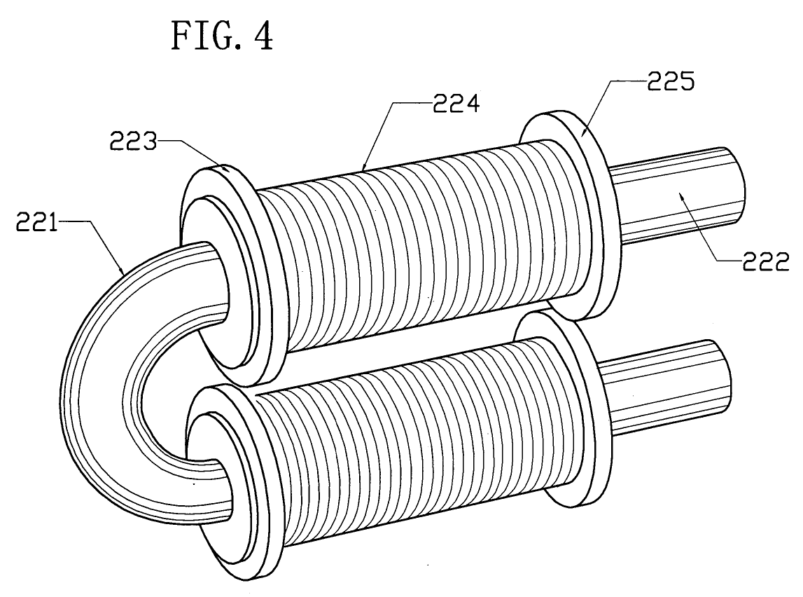

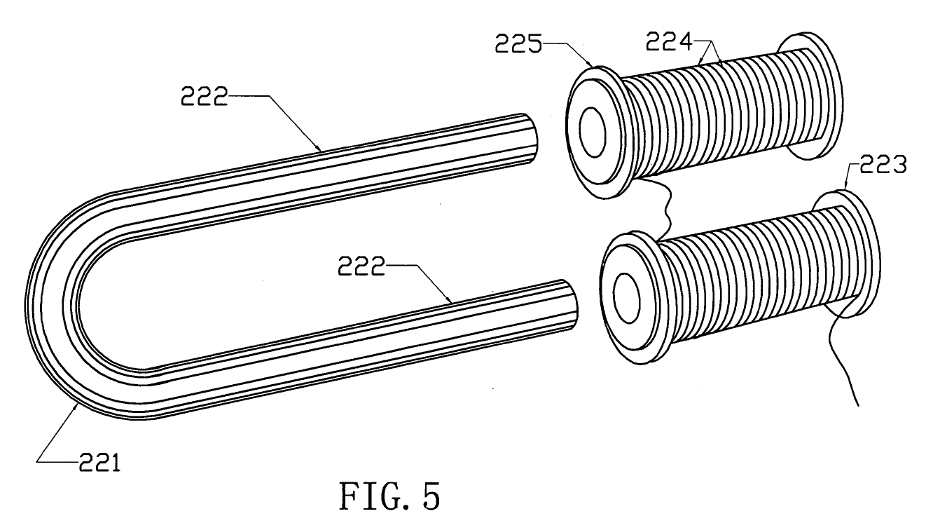

The electromagnetism of the toy 10 is achieved through the electromagnetic modules 22. Each of the modules 22 (shown in detail in FIGS. 4 and 5) includes a U-shaped iron core 221. Each of the core legs 222 receives a conductive loop 223. For ease of construction, the conductive loops 223 are formed with a plurality of wire windings 224 around a central spool 225. The spool is not required to cerate a magnetic field, but it si a convenient way to install a large number of windings 224 quickly and easily. The electromagnetic modules 22 are then secured in the leg 14 of the housing 12 by a pair of end caps 28.

The iron core 201 is oriented so that its longitudinal cross section is perpendicular to a longitudinal cross section of the housing 12. While other configurations are certainly feasible and will work properly, this conformation allows the maximum amount of electrical windings 224 to be positioned in a minimum volume with a quick and easy assembly process. The numerous windings 224 enable the toy magnet 10 of the present invention to exert a strong magnetic field.

When a user wants to activate the electromagnetic toy 10, he simply pushes the switch 24 button to close the circuit between the power source 20 and the electromagnetic modules 22. When the switch 24 is closed, current flows through the conductive loops 223 around the legs 222 of the iron cores 221, which creates the desired magnetic field.

The above disclosure is not intended as limiting. Those skilled in the art will recognize that numerous modifications and alterations may be made while retaining the teachings of the invention. Accordingly, the above disclosure should be construed as limited only by the restrictions of the appended claims.

1. A toy electromagnet comprising:
a housing with a cavity therein, said cavity containing an independent DC power source so that said electromagnet is completely portable,
at least one leg extending outward from said housing,
a switch to activate said power source, and
at least one electromagnetic module; wherein
when said power source is activated by said switch, current flows through a plurality of windings around an iron core in said electromagnetic module, thereby creating a magnetic field around said at least one leg of said iron core.

2. The toy electromagnet of claim 1 wherein:
said housing further includes a handle, said switch being mounted on said handle.

3. The toy electromagnet of claim 1 wherein:
said at least one electromagnetic module comprises
said iron core, said iron core having at least one core leg, and
at least one conductive loop, said conductive loop comprising a central spool with said plurality of windings wrapped around said central spool; wherein
said conductive loop is mounted on said core leg.

4. The toy electromagnet of claim 1 wherein:
said at least one electromagnetic module comprises
said iron core, said iron core having a U shape with a pair of core legs, and
at least two conductive loops, each said conductive loop comprising a central spool with a set of said plurality of windings wrapped around said central spool; wherein
said conductive loops are mounted on said core legs.
